(19) United States
(12) Patent Application Publication
(10) Pub. No.: US 2023/0248198 A1
(43) Pub. Date: Aug. 10, 2023

(54) VACUUM CLEANER

(71) Applicant: Dyson Technology Limited, Wiltshire (GB)

(72) Inventors: Massimo CAMPLANI, Bristol (GB); Andrew Collingwood WATSON, Gloucester (GB); Nathan LAWSON MCLEAN, Bristol (GB)

(73) Assignee: Dyson Technology Limited, Wiltshire (GB)

(21) Appl. No.: 18/014,672

(22) PCT Filed: Jun. 3, 2021
(86) PCT No.: PCT/GB2021/051373

§ 371 Date: Jan. 5, 2023

(30) Foreign Application Priority Data
Jul. 10, 2020 (GB) 2010662.1

(51) Int. Cl. A47L 9/28; A47L 5/30; A47L 5/22; A47L 5/26; G01C 21/16

(52) U.S. Cl. CPC A47L 9/2842; A47L 9/2857; A47L 9/2831; A47L 9/2805; A47L 5/30; A47L 5/225; A47L 5/26; G01C 21/16

(57) ABSTRACT

A vacuum cleaner includes: a sensor configured to generate sensor signals based on sensed motion and orientation of the vacuum cleaner; a user input device; a vacuum motor; and a controller configured to: activate the vacuum motor in response to activation of the user input device by a user; in response to activation of the vacuum motor, process the generated sensor signals to determine whether the vacuum cleaner is actively being used by the user; and in response to determining that the vacuum cleaner is actively being used, retain the vacuum motor in an activated state.

### TECHNICAL FIELD

The present disclosure relates to a vacuum cleaner. In particular, but not exclusively, the present disclosure concerns measures, including methods, apparatus and computer programs, for operating a vacuum cleaner.

### BACKGROUND

Broadly speaking, there are four types of vacuum cleaner: ‘upright’ vacuum cleaners, ‘cylinder’ vacuum cleaners (also referred to as ‘canister’ vacuum cleaners), ‘handheld’ vacuum cleaners and ‘stick’ vacuum cleaners.

Upright vacuum cleaners and cylinder vacuum cleaners tend to be mains-power-operated.

Handheld vacuum cleaners are relatively small, highly portable vacuum cleaners, suited particularly to relatively low duty applications such as spot cleaning floors and upholstery in the home, interior cleaning of cars and boats etc. Unlike upright cleaners and cylinder cleaners, they are designed to be carried in the hand during use, and tend to be powered by battery.

Stick vacuum cleaners may comprise a handheld vacuum cleaner in combination with a rigid, elongate suction wand which effectively reaches down to the floor so that the user may remain standing while cleaning a floor surface. A floor tool is typically attached to the end of the rigid, elongate suction wand, or alternatively may be integrated with the bottom end of the wand.

Stick vacuum cleaners are typically operated by depressing a physical trigger switch, which causes the vacuum motor to activate. When the trigger switch is released, the vacuum motor is usually immediately deactivated. This has the benefit that the battery is not unnecessarily depleted, since the user is inclined to release the trigger when possible, for example when moving between different areas. Nevertheless, extended cleaning sessions in which the user is required to keep a physical trigger switch depressed can result in some mild discomfort for some users.

It is an object of the present disclosure to mitigate or obviate the above disadvantages, and/or to provide an improved or alternative vacuum cleaner.

### SUMMARY

According to an aspect of the present disclosure, there is provided a vacuum cleaner comprising: a sensor configured to generate sensor signals based on sensed motion and orientation of the vacuum cleaner; a user input device; a vacuum motor; and a controller configured to: activate the vacuum motor in response to activation of the user input device by a user; in response to activation of the vacuum motor, process the generated sensor signals to determine whether the vacuum cleaner is actively being used by the user; and in response to determining that the vacuum cleaner is actively being used, retain the vacuum motor in an activated state.

Advantageously, once the user input device has been activated by the user, the vacuum motor is activated and remains in an activated state provided the controller determines that the vacuum cleaner is actively being used by the user. In this manner, the user is not required to keep a physical trigger switch depressed in order to retain the vacuum motor in an activated state. This results in improved user comfort and convenience.

In embodiments, determining that the vacuum cleaner is actively being used by the user comprises determining that the user is holding and/or manoeuvring the vacuum cleaner in manner indicative of a vacuum cleaning operation.

In embodiments, the controller is further configured to deactivate the vacuum motor in response to determining that the vacuum cleaner is no longer actively being used by the user. In this manner, battery power is conserved because the vacuum motor is deactivated when the user stops cleaning.

In embodiments, determining that the vacuum cleaner is no longer actively being used by the user comprises determining that the user has not been holding and/or manoeuvring the vacuum cleaner in a manner indicative of vacuum cleaning operation for a pre-determined period of time. In this manner, the vacuum motor does not deactivate until a pre-determined period of time has elapsed, during which the controller determines that the user is not actively using the vacuum cleaner. This prevents the vacuum motor deactivating prematurely.

In embodiments, the pre-determined period of time is in the range 0.5 to 5 seconds.

In embodiments, following deactivation of the vacuum motor, the vacuum motor can only be reactivated by activation of the user input device by the user. This prevents the vacuum motor being accidentally re-activated if the vacuum cleaner is momentarily moved.

In embodiments, the user input device comprises a trigger switch and activation of the user input device comprises depressing the trigger switch.

In embodiments, activation of the user input device comprises depressing the trigger switch for a duration of less than 0.5 seconds followed by releasing the trigger switch.

In embodiments, the user input device comprises a capacitive sensor located in proximity to a handle of the vacuum cleaner, and activation of the user input device comprises gripping the handle.

In embodiments, the sensor signals are based only on sensed motion of the vacuum cleaner or only on sensed orientation of the vacuum cleaner.

In embodiments, the sensor comprises an inertial measurement unit, IMU.

In embodiments, the vacuum cleaner further comprises: a cleaner head comprising an agitator; and one or more diagnostic sensors configured to generate further sensor signals based on sensed parameters of the cleaner head, wherein the controller is configured to process the generated further sensor signals to determine whether the vacuum cleaner is actively being used by the user. In this manner, when additional sensors are available, the additional sensor data are used by the controller to determine whether the vacuum cleaner is actively being used.

In embodiments, the cleaner head further comprises an agitator motor arranged to rotate the agitator and the sensed parameters of the cleaner head comprise the agitator motor current.

In embodiments, the sensed parameters of the cleaner head comprise the pressure applied to the cleaner head.

In embodiments, the controller is configured to process the sensor signals by performing a pre-processing step and a classification step.

In embodiments, the pre-processing step comprises extracting features from time portions of the sensor signals.

In embodiments, the pre-processing step comprises filtering the sensor signals.

In embodiments, the classification step comprises processing the extracted features using a machine learning classifier. Advantageously, a machine learning classifier can be pre-trained, for example at the factory, by subjecting the vacuum cleaner to a multitude of different cleaning activities/scenarios and defining how the vacuum cleaner should respond in each case. Furthermore, the machine learning classifier may be capable of further learning in the user's home environment.

In embodiments, the machine learning classifier comprises one or more of: an artificial neural network, a random forest and a support-vector machine.

According to an aspect of the present disclosure, there is provided a method of operating a vacuum cleaner comprising: in response to a user activating a user input device of the vacuum cleaner, activating a vacuum motor of the vacuum cleaner; in response to activation of the vacuum motor, generating sensor signals based on sensed motion and orientation of the vacuum cleaner; processing the sensor signals to determine whether the vacuum cleaner is actively being used by the user; and in response to determining that the vacuum cleaner is actively being used by the user, retaining the vacuum motor in an activated state.

According to an aspect of the present disclosure, there is provided a computer program comprising a set of instructions, which, when executed by a computerised device, cause the computerised device to perform a method of operating a vacuum cleaner, the method comprising: in response to a user activating a user input device of the vacuum cleaner, activating a vacuum motor of the vacuum cleaner; in response to activation of the vacuum motor, generating sensor signals based on sensed motion and orientation of the vacuum cleaner; processing the sensor signals to determine whether the vacuum cleaner is actively being used by the user; and in response to determining that the vacuum cleaner is actively being used by the user, retaining the vacuum motor in an activated state.

The present disclosure is not limited to any particular type of vacuum cleaner. For example, the aspects of the disclosure may be utilised on upright vacuum cleaners, cylinder vacuum cleaners or handheld or ‘stick’ vacuum cleaners.

It should be appreciated that features described in relation to one aspect of the present disclosure may be incorporated into other aspects of the present disclosure. For example, a method aspect may incorporate any of the features described with reference to an apparatus aspect and vice versa.

### DESCRIPTION OF THE DRAWINGS

Embodiments of the present disclosure will now be described by way of example only with reference to the accompanying schematic drawings of which:

FIG. 1 is a perspective view of a stick vacuum cleaner according to an embodiment of the present disclosure;

FIG. 2 is a view of a cleaner head of the vacuum cleaner of FIG. 1, shown from underneath;

FIG. 3 is a schematic illustration of electrical components of the vacuum cleaner of FIG. 1;

FIG. 4 is a perspective view of a main body of the stick vacuum cleaner of FIG. 1;

FIGS. 5a and 5b illustrate sensor signals corresponding to linear and angular acceleration generated by an inertial measurement unit of a vacuum cleaner according to embodiments of the present disclosure;

FIGS. 6 and 7 illustrates further sensor signals corresponding to orientation generated by the inertial measurement unit of a vacuum cleaner according to embodiments of the present disclosure;

FIG. 8 is a simplified schematic illustration of electrical components of the vacuum cleaner of FIG. 3, showing electrical connections between sensors, a human-computer interface, motors and the controller according to embodiments of the present disclosure;

FIG. 9 is a block diagram illustrating example sensor signal processing performed by the controller according to various embodiments of the present disclosure;

FIG. 10 is a flow diagram showing a method of operating a vacuum cleaner without a trigger according to an embodiment of the present disclosure;

FIG. 11 illustrates example sensor signal processing performed by the controller applicable to the method illustrated in FIG. 10 according to embodiments of the present disclosure;

FIG. 12 is a flow diagram showing a method of operating a vacuum cleaner based on a latching trigger according to embodiments of the present disclosure;

FIG. 13 is a flow diagram showing a method of operating a vacuum cleaner based on a time of flight sensor and a capacitive sensor according to embodiments of the present disclosure;

FIGS. 14a and 14b illustrates an example cleaning activity applicable to the method illustrated in FIG. 13 according to embodiments of the present disclosure;

FIG. 15 is a flow diagram showing a method of operating a vacuum cleaner based on a motion and orientation sensor and parameters of a cleaner head according to embodiments of the present disclosure; and

FIGS. 16a and 16b illustrate an example cleaning activity applicable to the method illustrated in FIG. 15 according to embodiments of the present disclosure.

### DETAILED DESCRIPTION

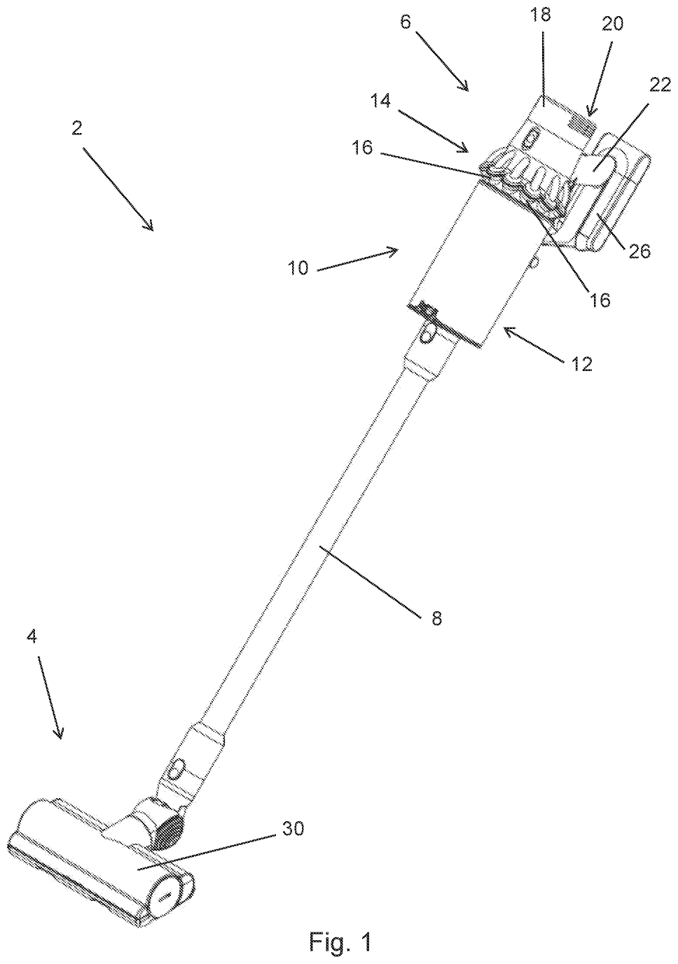

FIGS. 1 to 4 illustrate a vacuum cleaner 2 according to embodiments of the present disclosure. The vacuum cleaner 2 is a ‘stick’ vacuum cleaner comprising a cleaner head 4 connected to a main body 6 by a generally tubular elongate wand 8. The cleaner head 4 is also connectable directly to the main body 6 to transform the vacuum cleaner 2 into a handheld vacuum cleaner. Other removable tools, such as a crevice tool 3, a dusting brush 7 and a miniature motorized cleaner head 5 may be attached directly to the main body 6, or to the end of the elongate wand 8, to suit different cleaning tasks.

The main body 6 comprises a dirt separator 10 which in this case is a cyclonic separator. The cyclonic separator has a first cyclone stage 12 comprising a single cyclone, and a second cyclone stage 14 comprising a plurality of cyclones 16 arranged in parallel. The main body 6 also has a removable filter assembly 18 provided with vents 20 through which air can be exhausted from the vacuum cleaner 2. The main body 6 of the vacuum cleaner 2 has a pistol grip 22 positioned to be held by the user. At an upper end of the pistol grip 22 is a user input device in the form of a trigger switch 24, which is usually depressed in order to switch on the vacuum cleaner 2. However, in some embodiments the physical trigger switch 24 is optional. Positioned beneath a lower end of the pistol grip 22 is a battery pack 26 which comprises a plurality of rechargeable cells 27. A controller 50 and a vacuum motor 52, comprising a fan driven by an electric motor, are provided in the main body 6 behind the dirt separator 10.

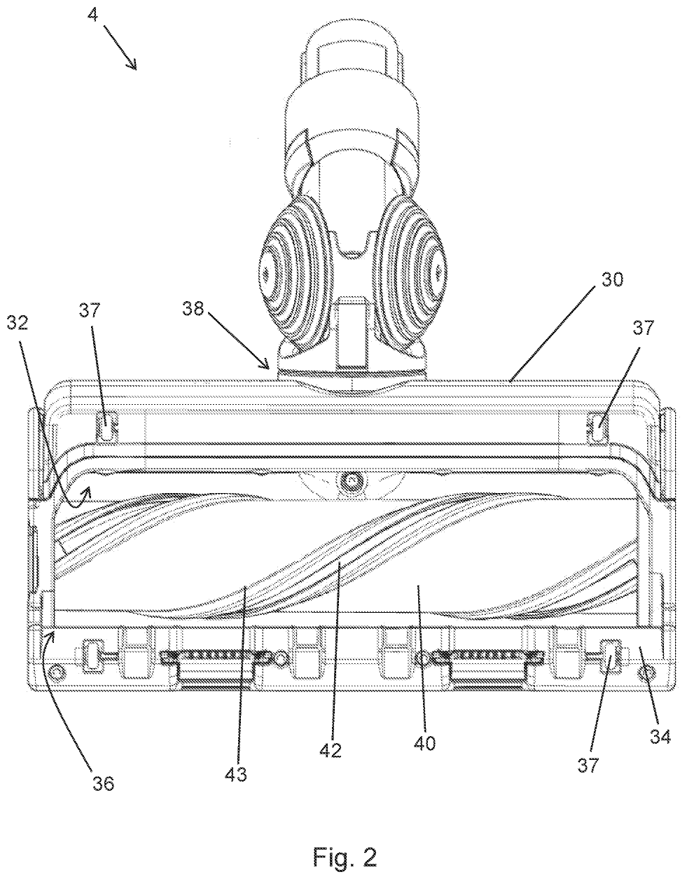

The cleaner head 4 is shown from underneath in FIG. 2. The cleaner head 4 has a casing 30 which defines a suction chamber 32 and a soleplate 34. The soleplate 34 has a suction opening 36 through which air can enter the suction chamber 32, and wheels 37 for engaging a floor surface. The casing 30 defines an outlet 38 through which air can pass from the suction chamber 32 into the wand 8. Positioned inside the suction chamber 32 is an agitator 40 in the form of a brush bar. The agitator 40 can be driven to rotate inside the suction chamber 32 by an agitator motor 54. The agitator motor 54 of this embodiment is received inside the agitator 40. The agitator 40 has helical arrays of bristles 43 projecting from grooves 42, and is positioned in the suction chamber such that the bristles 43 project out of the suction chamber 34 through the suction opening 36.

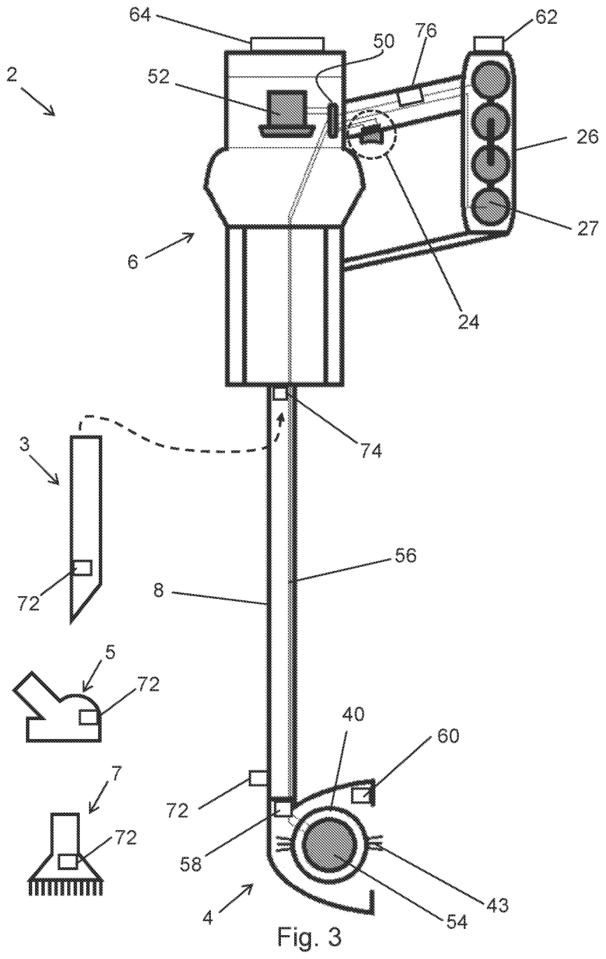

FIG. 3 is a schematic representation of the electrical components of the vacuum cleaner 2. The controller 50 manages the supply of electrical power from the cells 27 of the battery pack 26 to the vacuum motor 52. When the vacuum motor 52 is powered on, this creates a flow of air so as to generate suction. Air with dirt entrained therein is sucked into the cleaner head 4 (or, when attached, one of the other tools such as the crevice tool 3, the mini motorised cleaner head 5, or the dusting brush 7), into the suction chamber 32 through the suction opening 36. From there, the air is sucked through the outlet 38 of the cleaner head 4, along the wand 8 and into the dirt separator 10. Entrained dirt is removed by the dirt separator 10 and then relatively clean air is drawn through the vacuum motor 52, through the filter assembly 18 and out of the vacuum cleaner 2 through the vents 20. In addition, the controller 50 also supplies electrical power from the battery pack 26 to the agitator motor 54 of the cleaner head 4, through wires 56 running along the inside of the wand, so as to rotate the agitator 40. When the cleaner head 4 is on a hard floor, it is supported by the wheels 37 and the soleplate 34 and agitator 40 are spaced apart from the floor surface. When the cleaner head 4 is resting on a carpeted surface, the wheels 37 sink into the pile of the carpet and the soleplate 34 (along with the rest of the cleaner head 4) is therefore positioned further down. This allows carpet fibres to protrude towards (and potentially through) the suction opening 36, whereupon they are disturbed by bristles 43 of the rotating agitator 40 so as to loosen dirt and dust therefrom.

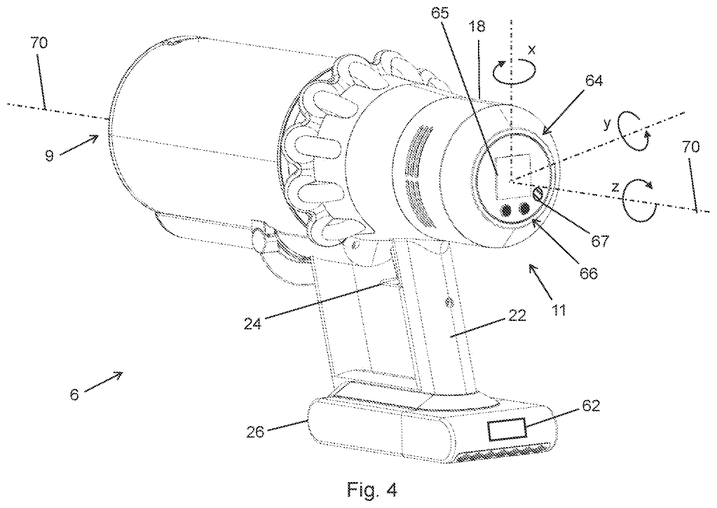

Vacuum cleaners 2 according to embodiments of the present disclosure comprise additional components, which are visible in FIGS. 3 and 4. These include one or more of: a current sensor 58 for sensing the electrical current drawn by the agitator motor 54 of the cleaner head 4, a pressure sensor 60 for sensing the pressure applied to the soleplate 34 of the cleaner head 4, an inertial measurement unit (IMU) 62 which is sensitive to motion and orientation of the main body 6 of the vacuum cleaner 2, a human computer interface (HCI) 64, one or more proximity sensors, typically in the form of time of flight (TOF) sensors 72, a tool switch sensor 74 and a capacitive sensor 76 located in the pistol grip 22. Although the current sensor 58 is shown as being situated in the cleaner head 4, it could alternatively be located in the main body 6. For example, the current sensor 58 could be integrated as part of the controller 50, provided it is operable to sense electrical current supplied to the agitator motor 54 from the battery 26 via the wires 56. In the illustrated embodiment, one TOF sensor 72 is located at the end of the detachable wand 8, close to where the cleaner head 4, or one of the other tools 3, 5, 7, is attached. Further TOF sensors 72 may be provided on the removable tools 3, 5, 7 themselves. Each TOF sensor 72 generates a sensor signal dependent on the proximity of objects to the TOF sensor 72. Suitable TOF sensors 72 include radar or laser devices. The tool switch sensor 74 is located on the main body 6 of the vacuum cleaner 2 and generates signals dependent on whether a tool 3, 4, 5, 7 or the wand 8 is attached to the main body 6. In embodiments, the tool switch sensor 74 generates signals dependent on the type of tool 3, 4, 5, 7 attached to main body 6 or the wand 8. The capacitive sensor 76 is located in the pistol grip 22 and generates signals dependent on whether a user is gripping the pistol grip. In embodiments, the vacuum cleaner 2 may comprise one or more additional IMUs. For example, the cleaner head 4 may comprise an IMU which is sensitive to motion and orientation of the cleaner head 4 and which generates further sensor signals to supplement those generated by the IMU 62 of the main body 6. The IMU 62 may comprise one or more accelerometers, one or more gyroscopes and/or one or more magnetometers.

As shown in more detail in FIG. 4, the main body 6 of the vacuum cleaner 2 defines a longitudinal axis 70 which runs from a front end 9 to a rear end 11 of the main body 6. When it is attached to the front end 9 of the main body 6, the wand 8 is parallel to (and in this case collinear with) the longitudinal axis 70. In the illustrated embodiment, the HCI 64 comprises a visual display unit 65, more particularly a planar, full colour, backlit thin-film transistor (TFT) screen. The screen 65 is controlled by the controller 50 and receives power from the battery 26. The screen displays information to the user, such as an error message, an indication of a mode the vacuum cleaner 2 is operating in, or an indication of remaining battery 26 life. The screen 65 faces substantially rearwards (i.e. its plane is orientated substantially normal to the longitudinal axis 70). Positioned beneath the screen 65 (in the vertical direction defined by the pistol grip 22) is a pair of control members 66, also forming part of the HCI 64 and each of which is positioned adjacent to the screen 65 and is configured to receive a control input from the user. In embodiments, the control members are configured to change the mode of the vacuum cleaner, for example to manually increase or decrease the power of the vacuum motor 52. In embodiments, the HCI 64 also comprises an audio output device such as a speaker 67 which can provide audible feedback to the user.

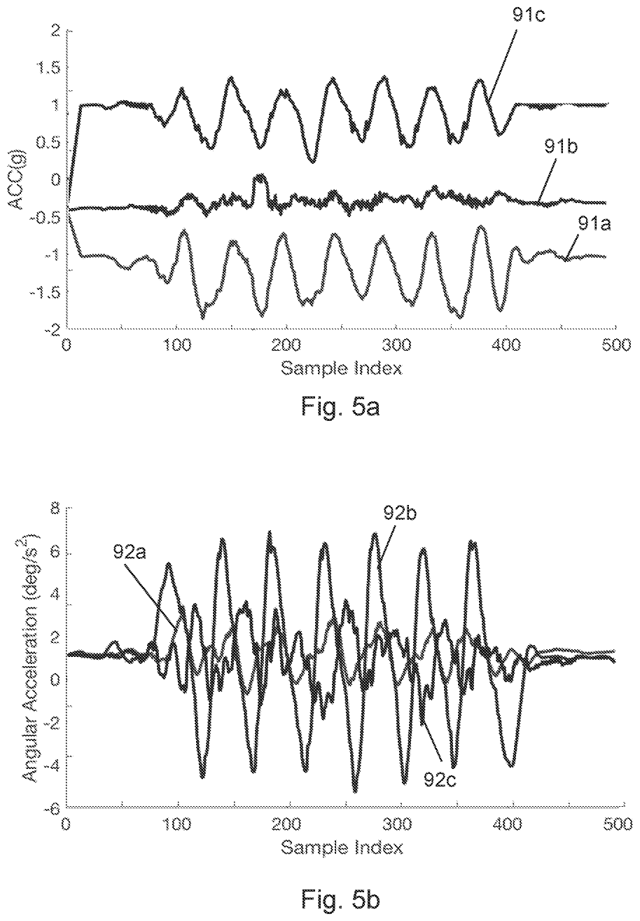

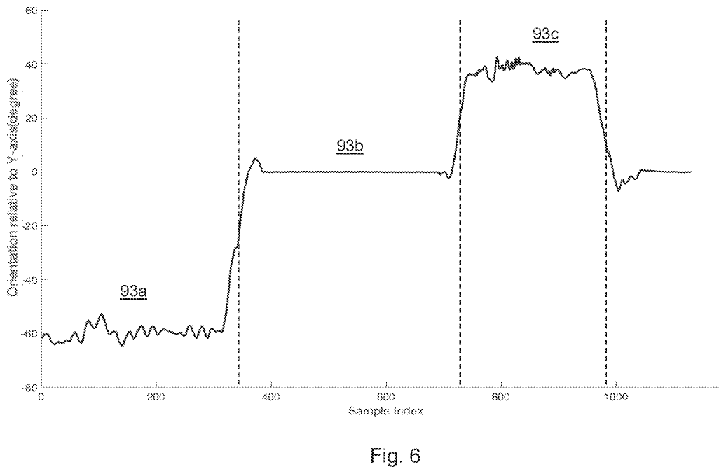

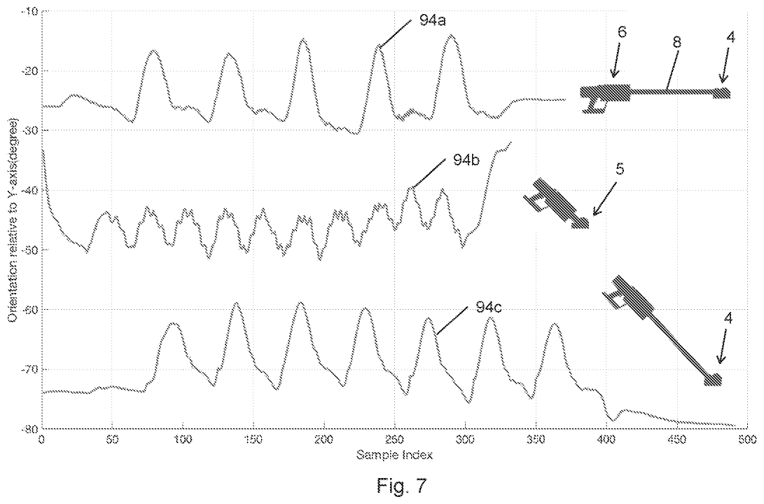

The IMU 62 generates sensor signals dependent on the motion and orientation of the main body 6 of the vacuum cleaner 2 in three spatial dimensions (x, y, and z). The motion includes the linear acceleration and angular acceleration of the main body 6. FIG. 5a illustrates exemplary generated IMU 62 sensor data corresponding to the linear acceleration of the main body 6 before, during and after a cleaning operation. The time scale shows the index of samples which were gathered at a sampling rate of 25 Hz. The vertical scale is in units of acceleration due to gravity. Traces 91a, 91b and 91c correspond to the linear acceleration of the main body 6 in the x, y and z directions respectively. FIG. 5b illustrates exemplary generated IMU 62 sensor data corresponding to the angular acceleration of the main body 6 before, during and after the same cleaning operation as represented in FIG. 5a. Traces 92a, 92b and 92c correspond to the angular acceleration about the x, y and z axes respectively. In both FIGS. 5a and 5b, the vacuum cleaner 2 is initially static (at rest). This is followed by a cleaning session comprising cleaning strokes, giving rise to oscillatory behaviour in some of the generated sensor data. Finally, the vacuum cleaner 2 is again returned to rest. The data shown in FIGS. 5a and 5b have been smoothed, for example by means of a band-pass filter or a low-pass filter. FIG. 6 illustrates example generated IMU 62 sensor data corresponding to of the orientation of the main body 6 about the y axis during different hand-held cleaning operations. Specifically, interval 93a corresponds to cleaning of a low-level surface, e.g. a skirting board, interval 93b corresponds to a period during which the main body 6 is at rest on a table and interval 93c corresponds to cleaning of an elevated surface, for example a ceiling, blind, curtain, or the top of a cupboard. FIG. 7 illustrates further exemplary generated IMU 62 sensor data corresponding to orientation of the main body 6 about the y axis during different cleaning operations using the motorized cleaner heads 4, 5. Trace 94a corresponds to cleaning under furniture using the main cleaner head 4 attached to the wand 8. Trace 94b corresponds to stair cleaning using the miniature motorized cleaner head 5 attached directly to the main body 6, without using the wand 8. Trace 94c corresponds to normal upright vacuum cleaning using the cleaner head 4 attached to the wand 8. It should be appreciated that the different cleaning activities give rise to different signatures in the sensor data generated by the IMU 62. In this manner, it should be appreciated that the IMU 62 sensor data can be processed to infer information about the cleaning activity being performed by a user using the vacuum cleaner, or about the environment in which the vacuum cleaner is being operated.

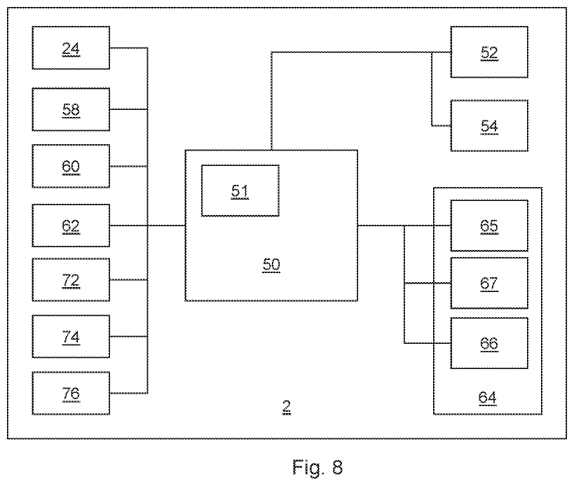

FIG. 8 illustrates schematically the electrical layout of the vacuum cleaner 2 according to embodiments. In embodiments, the controller 50 receives and processes signals generated by one or more of the trigger 24, the current sensor 58, the pressure sensor 60, the IMU 62, the one or more TOF sensors 72, the tool switch sensor 74 and the capacitive sensor 76. The controller 50 has a memory 51 on which are stored instructions according to which the controller 50 processes the sensor signals. Based on the processing of the sensor signals, the controller 50 controls one or more of the vacuum motor 52, the agitator motor 54 and the HCI 64 in order to enhance operation of the vacuum cleaner 2 and thereby improve the user experience. Example enhancements include improved pickup of dirt and improved battery life, amongst others.

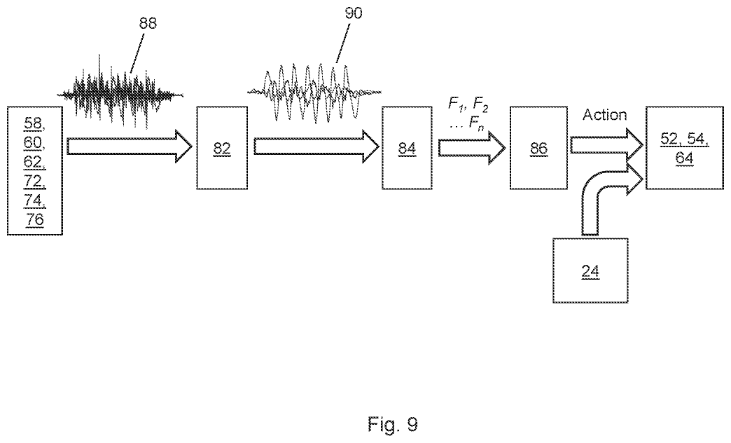

FIG. 9 is a block diagram which illustrates example sensor signal processing performed by the controller 50 according to various embodiments of the present disclosure. Unfiltered sensor signals 88 are received at the controller 50 from one or more of the available sensors. Different embodiments utilize sensor signals from different sensors. Some embodiments utilize sensor signals from only one sensor, such as the IMU 62, for example. A band-pass filter or low-pass filter 82 filters the raw sensor signals 88 to generate smoothed sensor signals 90 which are more suitable for further processing. At block 84, pre-determined features F₁, F₂ . . . Fₙ are extracted from the smoothed sensor signals and subsequently analysed by a classifier 86. In embodiments, the classifier 86 determines, from the extracted features, a particular cleaning activity being performed by a user using the vacuum cleaner 2. In other embodiments, the classifier 86 determines, from the extracted features a particular surface type on which the vacuum cleaner 2 is being operated. In other embodiments, the classifier 86 determines, from the extracted features, whether the vacuum cleaner 2 is actively being used, to assist in providing a trigger-less vacuum cleaner 2. Having determined the above, the controller 50 causes an action or actions to be performed involving one or more of the vacuum motor 52, agitator motor 54 and HCI 64, which are configured in dependence on the classifier 86 output, and optionally on the status of the trigger 24. It should be appreciated that the filter 82, feature extraction block 84 and classifier 86 are in general implemented as software modules which are executed on or under the control of the controller 50. The controller memory 51 stores sets of instructions defining the operation of the filter 82, feature extraction 84, classifier 86 and resultant action. In embodiments, the classifier is based on a machine learning classifier such as an artificial neural network, a random forest, a support-vector machine or any other appropriate trained model. The model could have been pre-trained, for example at the factory, using a supervised learning approach. A sliding window approach is generally used to span the filtered sensor signals and extract features corresponding to that particular time portion of the signal. Consecutive frames usually overlap to some degree but are usually processed separately. It should be appreciated that it is not always necessary to receive and process sensor data from all of the available sensors. For example, in embodiments the controller 50 may process only IMU 62 sensor data to obtain a classifier output. Furthermore, in the case of IMU 62 sensor data, the controller 50 may for example take account only of IMU 62 sensor data relating to orientation of the vacuum cleaner 2, or only IMU 62 sensor data relating to acceleration of the vacuum cleaner 2.

Although the vacuum cleaner 2 illustrated in FIGS. 1 to 4 includes a physical trigger 24 generally used to activate the vacuum motor 52 when the trigger 24 is depressed, it has been appreciated that for reasons of user comfort it is desirable to relax the requirement to keep the trigger 24 depressed during a vacuum cleaning operation. Indeed, some of the embodiments described below enable the vacuum cleaner 2 to be operated without depressing the trigger 24 at all. Accordingly, in embodiments, the provision of a physical trigger 24 may be optional, such that it can be entirely omitted from the vacuum cleaner 2.

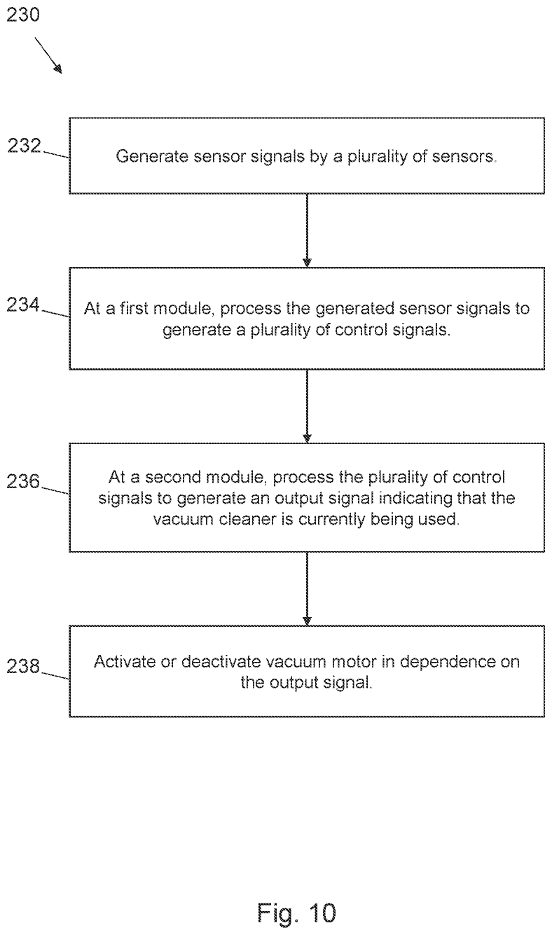

FIG. 10 is a flow diagram showing a method 230 of operating a vacuum cleaner 2 according to embodiments. In step 232, sensor signals are generated by a plurality of different sensors of the vacuum cleaner. These could include any combination of the IMU 62, the TOF sensors 72, the current sensor 58, the pressure sensor 60, the capacitive sensor 76 and the tool switch sensor 74. In step 234, a first module of the controller 50 processes the generated sensor signals to generate a plurality of control signals. In step 236, a second module of the controller 50 processes the plurality of control signals to generate an output signal indicating that the vacuum cleaner 2 is currently being used. In step 238, the vacuum motor 52 is activated or deactivated in dependence on the output signal.

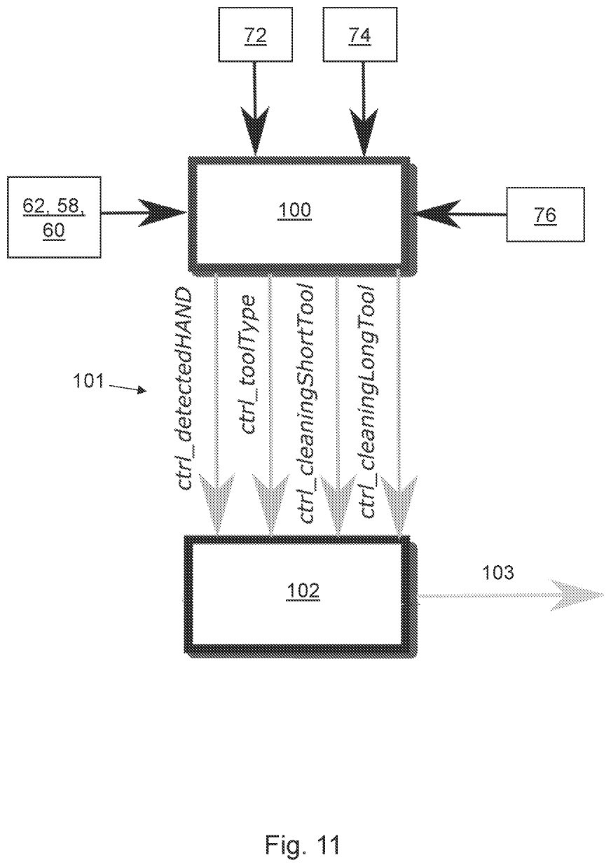

With reference to FIG. 11, the first module 100 receives sensor signals generated by the various sensors available on the vacuum cleaner 2. It should be appreciated that at times, not all sensors are necessarily present, i.e. installed on the device For example, in embodiments where the current sensor 58 and the pressure sensor 60 are located on or within the detachable cleaner head 4, but the vacuum cleaner 2 is being operated in conjunction with the crevice tool 7, instead of with the cleaner head 4, the current sensor 58 and the pressure sensor 60 are not at that time present. However, the general architecture set out in FIG. 11 is flexible in terms of adding or removing sensors providing signals to the first module 100. The first module 100 periodically generates (e.g. once per second) a plurality of control signals 101 based on the processing of the generated sensor signals. For example, control signal “ctrl_detectedHAND” is indicative of whether or not a user is gripping the handle (pistol grip 22) of the vacuum cleaner 2 as sensed for example by the capacitive sensor 76. Control signal “ctrl_toolType” is indicative of the type of tool 3, 4, 5, 7 attached to the main body 6 or wand 8, as sensed by the tool switch sensor 74. Control signal “ctrl_cleaningShortTool” is indicative of whether the user is manoeuvring the vacuum cleaner 2 in a manner indicative of a cleaning operation using a tool attached directly to the main body 6. Control signal “ctrl_cleaningLongTool” is indicative of whether the user is manoeuvring the vacuum cleaner in a manner indicative of a cleaning operation using a tool attached to the wand 8. The processing of generated sensor signals performed by the first module 100 is, in embodiments, based on the approach described above with reference to FIG. 9. Specifically, in embodiments, the first module 100 is configured to process the generated sensor signals by performing a pre-processing step (filtering and feature extraction) and a classification step (based on a machine learning classifier). In this regard, the classifier 86 is configured to provide the plurality of control signals 101.

The plurality of control signals are analysed by the second module 102 which produces an output signal 103 in dependence on the control signals 101. The vacuum motor 52 is activated or deactivated depending on the value of the output signal 103. In embodiments, the output signal is a binary signal which switches the vacuum motor 52 on and off at an initial default power level. In other embodiments, the output signal may take one of several values, allowing the vacuum motor 52 to be switched on at different initial power levels (e.g. low, medium and high) depending on the plurality of control signals 101. An appropriate architecture for the second module 102 is a finite state machine, where the different states correspond to states (power levels or on/off status) of the vacuum motor 52. It should be appreciated that the first 100 and second 102 modules may be implemented as separate software modules or a single software module executed by the single controller 50. The provision of first 100 and second 102 modules at different stages in the signal processing chain, set out in FIG. 11, enables independent development of the two modules. For example, changes to the way in which the classifier operates in the first module 100 do not necessarily impact upon the operation of the second module 102 provided the output control signals 101 adopt a consistent format. It should be appreciated that the general architecture described with reference to FIGS. 10 and 11 may form the basis for a trigger-less vacuum cleaner 2 according to embodiments of the present disclosure.

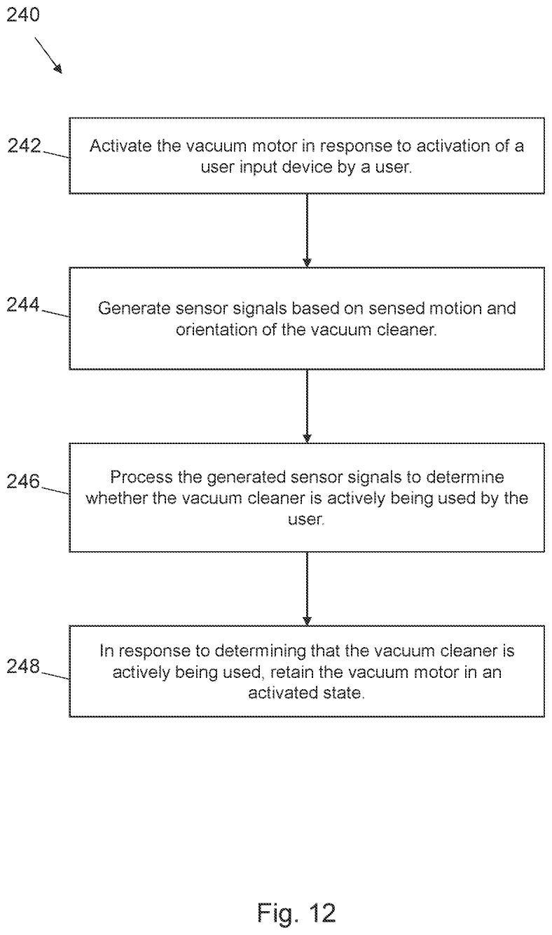

FIG. 12 is a flow diagram showing a method 240 of operating a vacuum cleaner 2 according to embodiments. In step 242, the vacuum motor 52 is activated (i.e. switched on) in response to activation of a user input device by a user. In step 244, sensor signals are generated based on sensed motion and orientation of the vacuum cleaner. In step 246, the generated sensor signals are processed by the controller 50 to determine whether the vacuum cleaner 2 is actively being used by the user. In step 248, in response to determining that the vacuum cleaner 2 is actively being used, the vacuum motor 52 is retained in an activated state. The user input device is typically the trigger 24, such that activation of the user input device involves depressing the trigger 24. However, unlike conventional triggered devices, the user does not necessarily need to keep the trigger 24 depressed continuously during a vacuum cleaning session. This is because the vacuum motor 52 is retained in an activated state provided the controller 50 determines that the vacuum cleaner 2 is actively being used by the user. As such, the vacuum cleaner 2 can be switched on by momentarily depressing the trigger 24, for example for a duration of less than half a second. Once switched on, the trigger 24 can be released, which improves user comfort. Therefore, the trigger effectively ‘latches’ (in a non-mechanical sense). The capacitive sensor 76 located in the pistol grip 22 may form part or all of the user input device. For example, instead of a physical trigger 24, the action of the capacitive sensor 76 detecting a user's hand may cause activation of the vacuum motor 52.

In embodiments, determining that the vacuum cleaner is actively being used by the user comprises determining that the user is holding and/or manoeuvring the vacuum cleaner in a manner indicative of a vacuum cleaning operation. In this regard, the controller 50 processes sensor signals, such as those produced by the IMU 62, in the manner described above with reference to FIG. 9. If the controller 50 determines that the vacuum cleaner is no longer actively being used, for example when it is set down on a table, the controller 50 deactivates the vacuum motor 52 in order to conserve battery power. The controller 50 will generally wait for a pre-determined period of time (e.g. 0.5 to 5 seconds) before deactivating the vacuum motor 52 to avoid the vacuum motor 52 switching off when the device is stationary only momentarily. If no movement is detected during this pre-determined period then the vacuum motor 52 is deactivated. Once deactivated, the user is generally required to ‘re-latch’ the vacuum cleaner 2, for example by briefly depressing the trigger 24, before the vacuum motor 52 can be reactivated. In other words, merely moving the vacuum cleaner 2 around will not, in embodiments, cause the vacuum motor 52 to reactivate once it has been deactivated following a period of inactivity. Additional sensor readings may be taken to determine whether the user is actively using the vacuum cleaner. Examples include readings from the current sensor 58 and the pressure sensor 60 which sense parameters of the cleaner head 4.

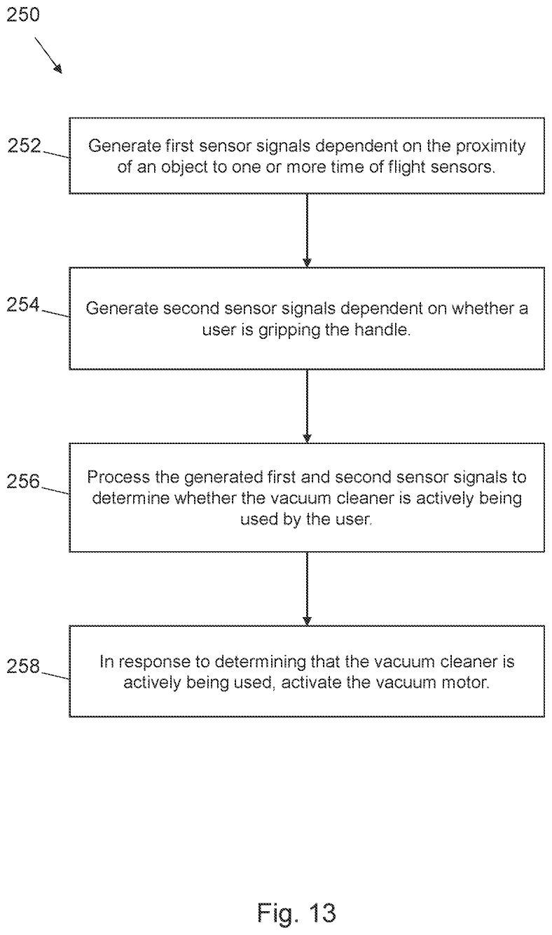

FIG. 13 is a flow diagram showing a method 250 of operating a vacuum cleaner 2 according to embodiments. In step 252, first sensor signals are generated by the one or more TOF sensors 72. The first sensor signals are dependent on the proximity of an object to the one or more TOF sensors 72. In step 254, second sensor signals are generated by the capacitive sensor 76, which are dependent on whether a user is gripping the handle 22 of the vacuum cleaner. In step 256, the first and second sensor signals are processed by the controller 50 to determine whether the vacuum cleaner 2 is actively being used by the user. In step 258, in response to determining that the vacuum cleaner 2 is actively being used, the vacuum motor 52 is activated. The controller 50 processes sensor signals in the manner described above with reference to FIG. 9.

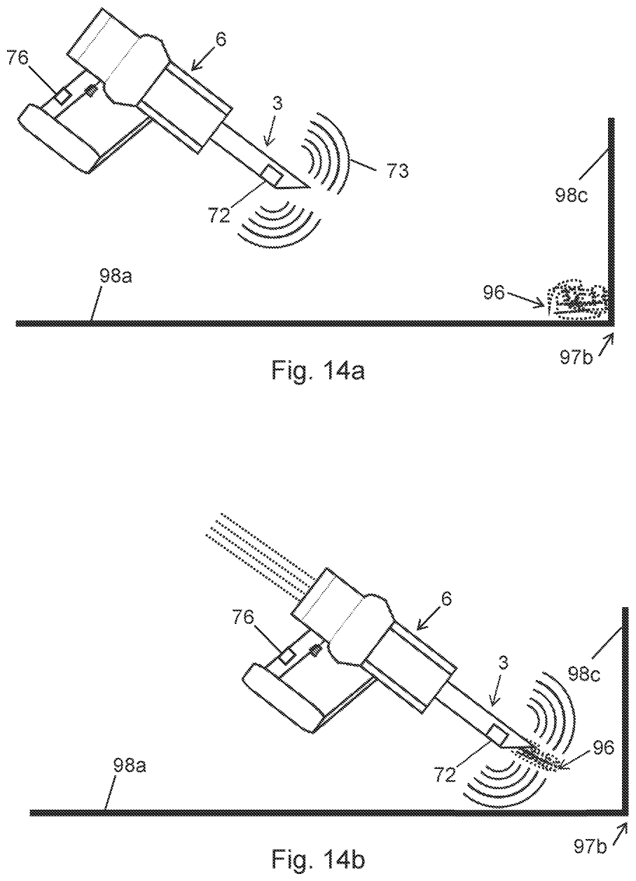

FIGS. 14a and 14b illustrate an example scenario in which a TOF sensor 72 and a capacitive sensor 76 are used to trigger the vacuum cleaner 2. In this example, a crevice tool 3 comprising a TOF sensor 72 is attached directly to the main body 6. The user desires to clean some dirt 96 from a crevice 97b formed between the floor 98a and the wall 98c. In FIG. 14a, the user's hand (not shown) is gripping the pistol grip 22 of the main body 6, which is detected by the capacitive sensor 76 located in the handle 22. The TOF sensor 72 may be a radar device or a laser device which emits and receives electromagnetic or acoustic radiation 73 in order to determine the proximity of objects and surfaces. In FIG. 14a, the TOF sensor 72 detects that the object, in this case the crevice 97b, is further away than a pre-determined threshold distance. Therefore the vacuum motor 52 is not yet activated and remains switched off, thus conserving battery power. In FIG. 14b, the user has moved the vacuum cleaner 2 closer to the crevice 97b, bringing it within a pre-determined threshold distance from the TOF sensor 72. Accordingly, the controller 50 determines that the vacuum cleaner 2 is actively being used and activates the vacuum motor 52 in time to effectively remove the dirt 96. When the user moves the vacuum cleaner 2 away from the crevice 97b, this is detected by the TOF sensor 72 and the vacuum motor 52 is deactivated. Accordingly, the vacuum cleaner 2 is activated and deactivated as required without the user having to depress a physical trigger 24. When the vacuum cleaner 2 is stored, the user's hand will not be gripping the handle 22, and therefore the vacuum motor 52 will not activate even if objects are within the pre-determined distance from the TOF sensor 72. In embodiments, the predetermined threshold distance is dependent on the type of detachable tool attached to the vacuum cleaner 2. This may be desirable to tailor the response of the vacuum cleaner 2 to different cleaning scenarios. For example, when using a dusting brush 7, the pre-determined threshold distance may be less than when using the crevice tool 3, since the vacuum motor 52 is only required to activate when dusting brush 7 is actually resting on the surface being cleaned.

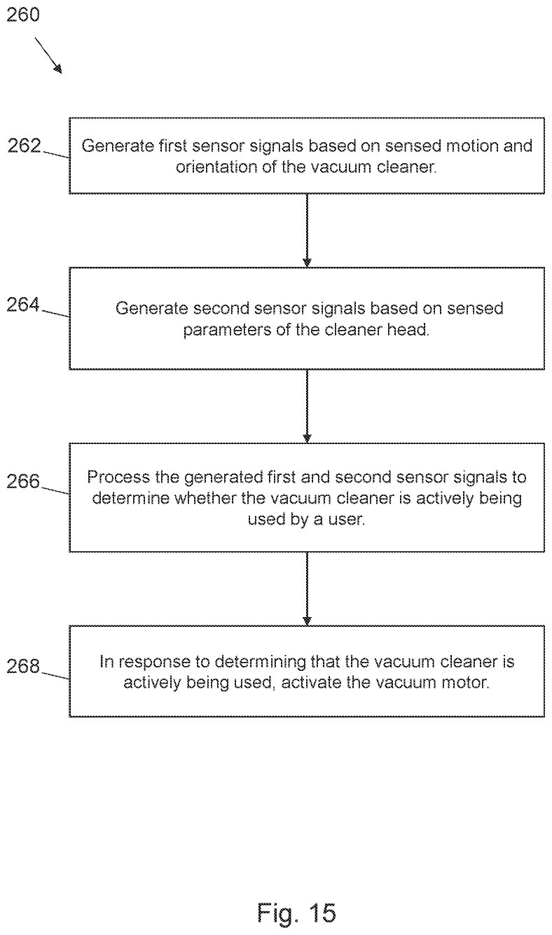

FIG. 15 is a flow diagram showing a method 260 of operating a vacuum cleaner 2 having a cleaner head 4 according to embodiments. In step 262, first sensor signals are generated based on sensed motion and orientation of the vacuum cleaner. The first sensor signals may be generated by the IMU 62, for example. In step 264, second sensor signals are generated based on sensed parameters of the cleaner head 4. The second sensor signals may be generated by the current sensor 58 and/or the pressure sensor 60. In step 266, the first and second sensor signals are processed by the controller 50 to determine whether the vacuum cleaner 2 is actively being used by the user. In step 268, in response to determining that the vacuum cleaner 2 is actively being used, the vacuum motor 52 is activated. The controller 50 processes sensor signals in the manner described above with reference to FIG. 9.

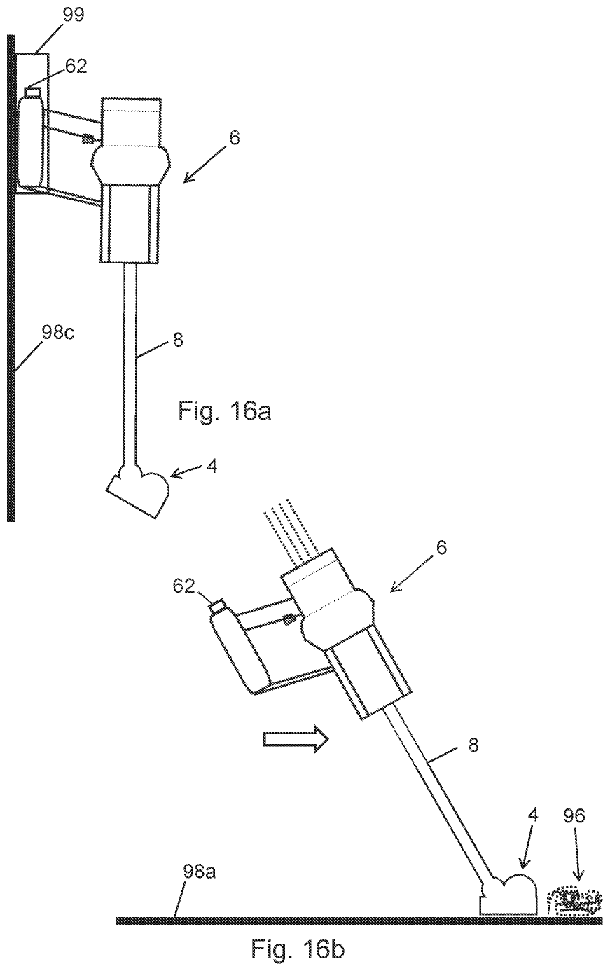

FIGS. 16a and 16b illustrate an example scenario in which the first and second sensor signals are used to trigger operation of the vacuum cleaner 2. In FIG. 16a the vacuum cleaner 2 is at rest within a dock 99 mounted to the wall 98c. The cleaner head 4 is attached to the wand 8 which in turn is attached to the main body 6. The pressure applied to the cleaner head 4 is small or zero when the vacuum cleaner 2 is suspended in the dock 99 in this manner. Furthermore, the IMU 62 will sense that the vacuum cleaner 2 is not undergoing any motion and remains in a fixed orientation. In FIG. 16b, the vacuum cleaner 2 has been taken out of the dock 99 by a user. The cleaner head 4 is resting on the floor 98a and the user begins to move the vacuum cleaner 2 forwards in order to start cleaning the floor. The controller 50 processes the sensor signals from the IMU 62 and the diagnostic sensors 58, 60 associated with the cleaner head 4 in the manner described above with reference to FIG. 9. This allows the controller 50 to determine that the user is now actively using the vacuum cleaner 2. Accordingly, the controller 50 activates the vacuum motor 52 without the user having to depress a trigger 24.

It is to be understood that any feature described in relation to any one embodiment and/or aspect may be used alone, or in combination with other features described, and may also be used in combination with one or more features of any other of the embodiments and/or aspects, or any combination of any other of the embodiments and/or aspects. For example, it will be appreciated that features and/or steps described in relation to a given one of the methods 230, 240, 250, 260 may be included instead of or in addition to features and/or steps described in relation to other ones of the methods 230, 240, 250, 260.

In embodiments of the present disclosure, the vacuum cleaner 2 comprises a controller 50. The controller 50 is configured to perform various methods described herein. In embodiments, the controller comprises a processing system. Such a processing system may comprise one or more processors and/or memory. Each device, component, or function as described in relation to any of the examples described herein, for example the IMU 62 and/or HCI 64 may similarly comprise a processor or may be comprised in apparatus comprising a processor. One or more aspects of the embodiments described herein comprise processes performed by apparatus. In some examples, the apparatus comprises one or more processors configured to carry out these processes. In this regard, embodiments may be implemented at least in part by computer software stored in (non-transitory) memory and executable by the processor, or by hardware, or by a combination of tangibly stored software and hardware (and tangibly stored firmware). Embodiments also extend to computer programs, particularly computer programs on or in a carrier, adapted for putting the above described embodiments into practice. The program may be in the form of non-transitory source code, object code, or in any other non-transitory form suitable for use in the implementation of processes according to embodiments. The carrier may be any entity or device capable of carrying the program, such as a RAM, a ROM, or an optical memory device, etc.

The one or more processors of processing systems may comprise a central processing unit (CPU). The one or more processors may comprise a graphics processing unit (GPU). The one or more processors may comprise one or more of a field programmable gate array (FPGA), a programmable logic device (PLD), or a complex programmable logic device (CPLD). The one or more processors may comprise an application specific integrated circuit (ASIC). It will be appreciated by the skilled person that many other types of device, in addition to the examples provided, may be used to provide the one or more processors. The one or more processors may comprise multiple co-located processors or multiple disparately located processors. Operations performed by the one or more processors may be carried out by one or more of hardware, firmware, and software. It will be appreciated that processing systems may comprise more, fewer and/or different components from those described.

The techniques described herein may be implemented in software or hardware, or may be implemented using a combination of software and hardware. They may include configuring an apparatus to carry out and/or support any or all of techniques described herein. Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program. The carrier may comprise a computer readable storage media. Examples of tangible computer-readable storage media include, but are not limited to, an optical medium (e.g., CD-ROM, DVD-ROM or Blu-ray), flash memory card, floppy or hard disk or any other medium capable of storing computer-readable instructions such as firmware or microcode in at least one ROM or RAM or Programmable ROM (PROM) chips.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the present disclosure that are described as preferable, advantageous, convenient or the like are optional and do not limit the scope of the independent claims. Moreover, it is to be understood that such optional integers or features, whilst of possible benefit in some embodiments of the present disclosure, may not be desirable, and may therefore be absent, in other embodiments.

1. A vacuum cleaner comprising:
a sensor configured to generate sensor signals based on sensed motion and orientation of the vacuum cleaner;
a user input device;
a vacuum motor; and
a controller configured to:
activate the vacuum motor in response to activation of the user input device by a user;
in response to activation of the vacuum motor, process the generated sensor signals to determine whether the vacuum cleaner is actively being used by the user; and
in response to determining that the vacuum cleaner is actively being used, retain the vacuum motor in an activated state.

2. The vacuum cleaner of claim 1, wherein determining that the vacuum cleaner is actively being used by the user comprises determining that the user is holding and/or manoeuvring the vacuum cleaner in manner indicative of a vacuum cleaning operation.

3. The vacuum cleaner of claim 1, wherein the controller is further configured to deactivate the vacuum motor in response to determining that the vacuum cleaner is no longer actively being used by the user.

4. The vacuum cleaner of claim 3, wherein determining that the vacuum cleaner is no longer actively being used by the user comprises determining that the user has not been holding and/or manoeuvring the vacuum cleaner in a manner indicative of vacuum cleaning operation for a pre-determined period of time.

5. The vacuum cleaner of claim 4, wherein the pre-determined period of time is in the range 0.5 to 5 seconds.

6. The vacuum cleaner of claim 3, wherein following deactivation of the vacuum motor, the vacuum motor can only be reactivated by activation of the user input device by the user.

7. The vacuum cleaner of claim 1,
wherein the user input device comprises a trigger switch, and
wherein activation of the user input device comprises depressing the trigger switch.

8. The vacuum cleaner of claim 7, wherein activation of the user input device comprises depressing the trigger switch for a duration of less than 0.5 seconds followed by releasing the trigger switch.

9. The vacuum cleaner of claim 1,
wherein the user input device comprises a capacitive sensor located in proximity to a handle of the vacuum cleaner, and
wherein activation of the user input device comprises gripping the handle.

10. The vacuum cleaner of claim 1, wherein the sensor signals are based only on sensed motion of the vacuum cleaner or only on sensed orientation of the vacuum cleaner.

11. The vacuum cleaner of claim 1, wherein the sensor comprises an inertial measurement unit, IMU.

12. The vacuum cleaner of claim 1, further comprising:
a cleaner head comprising an agitator; and
one or more diagnostic sensors configured to generate further sensor signals based on sensed parameters of the cleaner head,
wherein the controller is configured to process the generated further sensor signals to determine whether the vacuum cleaner is actively being used by the user.

12. The vacuum cleaner of claim 12,
wherein the cleaner head further comprises an agitator motor arranged to rotate the agitator, and
wherein the sensed parameters of the cleaner head comprise the agitator motor current.

14. The vacuum cleaner of claim 12, wherein the sensed parameters of the cleaner head comprise the pressure applied to the cleaner head.

15. The vacuum cleaner of claim 1, wherein the controller is configured to process the sensor signals by performing a pre-processing step and a classification step.

16. The vacuum cleaner of claim 15, wherein the pre-processing step comprises extracting features from time portions of the sensor signals.

17. The vacuum cleaner of claim 15, wherein the pre-processing step comprises filtering the sensor signals.

18. The vacuum cleaner of claim 16, wherein the classification step comprises processing the extracted features using a machine learning classifier.

19. The vacuum cleaner of claim 18, wherein the machine learning classifier comprises one or more of: an artificial neural network, a random forest and a support-vector machine.

20. A method of operating a vacuum cleaner comprising:
in response to a user activating a user input device of the vacuum cleaner, activating a vacuum motor of the vacuum cleaner;
in response to activation of the vacuum motor, generating sensor signals based on sensed motion and orientation of the vacuum cleaner;
processing the sensor signals to determine whether the vacuum cleaner is actively being used by the user; and
in response to determining that the vacuum cleaner is actively being used by the user, retaining the vacuum motor in an activated state.

21. A computer program comprising a set of instructions, which, when executed by a computerised device, cause the computerised device to perform a method of operating a vacuum cleaner, the method comprising:
in response to a user activating a user input device of the vacuum cleaner, activating a vacuum motor of the vacuum cleaner;
in response to activation of the vacuum motor, generating sensor signals based on sensed motion and orientation of the vacuum cleaner;
processing the sensor signals to determine whether the vacuum cleaner is actively being used by the user; and
in response to determining that the vacuum cleaner is actively being used by the user, retaining the vacuum motor in an activated state.
